(19) United States
(12) Patent Application Publication
(10) Pub. No.: US 2019/0228305 A1
(43) Pub. Date: Jul. 25, 2019

(54) VEHICLE SYSTEM FOR IDENTIFYING AND LOCALIZING NON-AUTOMOBILE ROAD USERS BY MEANS OF SOUND

(71) Applicant: ZF Friedrichshafen AG, Friedrichshafen (DE)

(72) Inventors: Debora Lovison, Friedrichshafen (DE); Florian Ade, Langenargen (DE); Julian Fieres, Schweinfurt (DE); Lucas Hanson, Friedrichshafen (DE); Anja Petrich, Kressbronn-Gohren (DE)

(73) Assignee: ZF Friedrichshafen AG, Friedrichshafen (DE)

(21) Appl. No.: 16/252,274

(22) Filed: Jan. 18, 2019

(30) Foreign Application Priority Data
Jan. 19, 2018 (DE) 102018200876.0

(51) Int. Cl. G06N 3/08; G06N 20/00

(52) U.S. Cl. CPC G06N 3/08; G06N 20/00

(57) ABSTRACT

A training system (10) for a street vehicle (1) for detecting non-automobile road users (2) based on sounds, comprising an input interface (11) for receiving target training data (12), wherein the target training data (12) are audio recordings (17) of the non-automobile road user (2) recorded by at least one microphone (3a, 3b, 3c, 3d) located on the street vehicle (1) while driving the street vehicle (1), and respective associated target characteristics (18a) of this non-automobile road user (2), and wherein the training system (10) is configured to forward propagate an artificial neural network (13) with the target training data (12) and to record an actual characteristic (18b) of the respective non-automobile road user (2) determined with the artificial neural network (13) in the forward propagation, and to obtain weighting factors (14) for the connections (15) of neurons (16) in the artificial neural network (13) through backward propagation of the artificial neural network (13) with the difference (19) between the determined actual characteristic (18b) and the associated target characteristic (18a). The invention also relates to a corresponding training process, an evaluation device, an operating system, use of an operating system according to the invention, and an operational process.

The subject matter of the invention comprises the detection of non-automobile road users by means of an artificial neural network based on typical sounds of the non-automobile road users.

In detail, the invention relates to a training system for a street vehicle for detecting non-automobile road users based on sounds according to claim 1. Furthermore, the invention relates to a training process for an artificial neural network for detecting non-automobile road users based on sounds according to claim 2. Moreover, the invention relates to an evaluation device for a road vehicle for detecting non-automobile road users based on sounds according to claim 4. The invention also relates to an operating system for a street vehicle for detecting non-automobile road users based on sounds according to claim 8. In addition, the invention relates to the use of an operating system according to the invention forming a driver assistance system according to claim 10. Lastly, the invention relates to an operational process for detecting non-automobile road users based on sounds according to claim 11.

Known wheel, lidar and image sensors in driver assistance systems detect objects in the visible surroundings of a vehicle by means of corresponding electromagnetic waves. If, however, these waves are obstructed between such a sensor and the object, the object cannot be detected with these sensors.

DE 10 2012 218 482 A1 discloses a driver assistance system that detects sounds in the surroundings reaching the vehicle from the outside.

The invention is based on this. The fundamental object of the invention is to detect non-automobile road users by means of sounds.

This problem is solved with
a training system for a street vehicle for detecting non-automobile road users based on sounds that has the features of claim 1,
a training process for an artificial neural network for detecting non-automobile road users based on sounds that has the features of claim 2,
an evaluation device for a street vehicle for detecting non-automobile road users based on sounds that has the features of claim 4,
an operating system for a street vehicle for detecting non-automobile road users based on sounds that has the features of claim 8,
use of an operating system according to the invention forming a driver assistance system according to claim 10, and
an operational process for detecting non-automobile road users based on sounds that has the features of claim 11.

Further developments and advantageous embodiments are given in the dependent claims.

The training system according to the invention for detecting non-automobile road users based on sounds for a street vehicle has an input interface for inputting target training data. The target training data comprise sound recordings of non-automobile road users recorded by at least one microphone on the street vehicle while driving the street vehicle, and respective associated target characteristics of these non-automobile road users. The training system is carried out to forward propagate an artificial neural network with the target training data. An actual characteristic of the respective non-automobile road user determined with the artificial neural network is obtained in the forward propagation. Weighting factors for connections of neurons in the artificial neural network are obtained by backward propagation of the artificial neural network with the difference between the determined actual characteristic and the associated target characteristic.

The following definitions apply to the entire subject matter of the invention.

Non-automobile road users are road users that participate in traffic that are not automobiles, i.e. passenger cars or trucks. These road users are more prone to danger from hazards arising in traffic than automobile road users protected by active and passive safety systems in the automobile, e.g. brakes, seatbelts, and/or airbag systems. Motorcycle drivers also belong to the automobile road users as set forth in this definition. Road users prone to danger include, in particular, pedestrians, bicyclists and riders of motorized bicycles, children and/or animals.

Sounds are noises that can be perceived by humans and/or sensors, e.g. sound converters, in particular microphones. Sounds from non-automobile road users that are prone to danger include bicycle bells, the barking of dogs, or the sounds of children.

Street vehicles are land vehicles that can maintain or alter their direction of travel by means of friction on a driving surface. Street vehicles are motor-operated vehicles, i.e. motor vehicles, e.g. automobiles or motorcycles. The invention focuses on civilian street vehicles.

An interface is a device incorporated between at least two functional units at which an exchange of logical variables, e.g. data or physical variables, e.g. electric signals, takes place, in either only one direction, or bidirectionally. The exchange can take place in a wireless or hard wired manner. An interface can exist between software and software, or hardware and hardware, as well as software and hardware and hardware and software.

The microphones installed on the street vehicle are microphones suitable for use with automobiles, i.e. protected against weather and functionally reliable. These microphones preferably have filters and/or gains, making them more sensitive to sounds from non-automobile road users than sounds from automobile road users. By way of example, motor noises and/or braking noises from automobiles are filtered out of the rest of the sounds. At least one microphone is preferably installed on each side of the street vehicle, i.e. at the front, back, left and right, i.e. there is a specific arrangement of microphones. The respective microphones are preferably directional microphones.

Target training data are positive training data with which a learning mechanism, e.g. an artificial neural network, learns factual information. Target training data are labeled with the meaning of the information, i.e. characterized, so that the learning mechanism can schematically record information. By way of example, small children have characteristic screaming behaviors with regard to volume and intonation, which may also be observable in traffic. Such a screaming is a target sound, in general comprising target information, for small children. This target sound is the input information for the learning mechanism. The volume and intonation of this screaming is recorded with a microphone. This audio recording is then labeled with the target characteristic “small child.” Other target sounds include the ringing of bicycle bells. These bells are labeled as “bicycle rider.” As an alternative to audio recordings recorded while driving the street vehicle, target training data can also comprise simulated sounds, e.g., that have been simulated with a computer.

The training system may also have a second input interface for receiving error training data within the framework of the invention. Error training data are negative training data, by means of which the learning mechanism learns to react to an error.

The actual characteristic is the characteristic that the learning mechanism receives after processing the target information, i.e. as output. At the start of the training phase, the recorded target characteristic is normally different from the input target characteristic. In the training phase, the difference between the actual characteristic and the target characteristic is reduced, normally according to the least squares method. The learning mechanism, e.g. the artificial neural network, completes the learning process after the training phase, and is trained. In a trained artificial neural network, the received actual characteristics are nearly identical to the target characteristics. The characteristic can also be an image.

An artificial neural network is an algorithm executed on an electronic circuit that has been programed on the basis of the neural network of the human brain. Functional units of an artificial neural network are artificial neurons, the output of which is generally evaluated as a value of an activation function via a weighted sum of the inputs plus a systematic error, the so-called bias. Artificial neural networks are trained by testing numerous predefined inputs with various weighting factors and/or activation functions, in a manner similar to that for the human brain. The training of an artificial neural network using predefined inputs, i.e. training target data, is referred to as mechanical learning. A subset of the mechanical learning is deep learning, in which a series of hierarchical layers of neurons, so-called hidden layers, are used for executing the mechanical learning process. An artificial neural network with numerous hidden layers is a deep neural network. A trained artificial neural network is distinguished by a purposeful reaction to new information. Examples of artificial neural networks include perceptrons and convolutional or recurrent neural networks. Connections between neurons are evaluated with weighting factors. The advance supplying, referred to in English as forward propagation, means that the information is supplied to the input layer of the artificial neural network, passes through the subsequent layers, and is output in the output layer. Reverse supplying, referred to in English as backward propagation, means that information is input into the output layer, and output in the input layer. The differences in the respective layers are obtained through successive backward propagation of the differences from the output layer into the respective preceding layer until reaching the input layer. The differences are a function of the weighting factors. The weighting factors are thus modified by minimizing the differences in the training phase. As a result, the desired output is approached through a renewed input. The backward propagation is described comprehensively in Michael A. Nielsen, Neural Networks and Deep Learning, Determination Press, 2015.

Because the frequency of children's voices differs from that of the adult voice, it is also possible to train the artificial neural network within the framework of the invention to classify the non-automobile road user sounds as belonging to either a child's voice or an adult's voice, based on the recorded frequency.

Numerous different children sounds can also be distinguished by the subject matter of the invention. Because children on streets often play with balls, the impact sounds of balls are one example of typical children sounds. Children can also be classified in combination with such typical children sounds.

The training process according to the invention for an artificial neural network for detecting non-automobile road users based on sounds includes the following steps:
provision of audio recordings recorded by at least one microphone on the street vehicle while driving a street vehicle, and the respective target characteristic of the non-automobile road user as target training data,
forward propagation of the artificial neural network with the target training data,
receiving an actual characteristic of the respective non-automobile road user determined with the artificial neural network,
backward propagation of the artificial neural network with the difference between the determined actual characteristic and the associated target characteristic, and
obtaining a weighting factor for connections of neurons in the artificial neural network in backward propagation.

The artificial neural network is thus trained by the training system and the training process, in order to learn to detect non-automobile road users based on sounds.

The target training data preferably comprise audio recordings of pedestrians, people playing, preferably children, athletes, preferably bicyclists, inline skaters, roller skaters, and/or joggers, people on scooters and in wheelchairs, pets, preferably dogs, and/or farm animals, preferably horses. In this manner, the artificial neural network learns to distinguish various non-automobile road users based on their specific sounds. Alternatively, the target training data are simulated, e.g. using a computer, sounds of pedestrians, people playing, preferably children, athletes, preferably bicyclists, inline skaters, roller skaters, and/or joggers, people on scooters and in wheelchairs, pets, preferably dogs, and/or farm animals, preferably horses.

The training system and/or the training process can also be implemented or carried out within the scope of the invention in different locations and/or countries and in different weather conditions. As a result, the artificial neural network learns to distinguish sounds under different conditions, and can thus detect more specifically non-automobile road users based on their sounds, independently of external influences.

The evaluation device according to the invention for a street vehicle for detecting non-automobile road users based on sounds has an input interface for receiving the sounds of non-automobile road users. The evaluation device is designed to forward propagate a trained artificial neural network with these sounds. The artificial neural network is trained to obtain characteristics of the non-automobile road users based on the sounds. Furthermore, the evaluation device has an output interface for outputting the characteristics of the non-automobile road users. Street vehicles that have no evaluation device can be easily be retrofitted therewith.

The output interface is advantageously a human-machine interface, referred to in English as a human machine interface, which can be integrated in an infotainment system in the street vehicle. The characteristics are output optically, e.g. by symbolically displaying the detected non-automobile road users in a display, hapticly, e.g. through vibrations in the steering wheel, or electronically in general.

The evaluation device is intended for non-automated and automated street vehicles. The evaluation device helps the human driver in non-automated street vehicles perceive non-automobile road users. The evaluation device in automated street vehicles helps the overall system of the street vehicle detect non-automobile road users.

The artificial neural network is preferably trained in accordance with the training process according to the invention.

The artificial neural network is preferably trained to determine positions and/or directions of movement of the non-automobile road users in relation to the evaluation device based on sounds. A collision of the street vehicle with these non-automobile road users can be anticipated and avoided based on the position and/or the direction of movement of a non-automobile road user in relation to the evaluation device. The position is determined by the artificial neural network from the respective signals from the directional microphones located on the street vehicle. The direction of movement is determined by the artificial neural network from a Doppler effect on the frequency of the incoming sounds.

The artificial neural network is trained to determine positions and/or directions of movement of the non-automobile road users with the training system and training process according to the invention.

According to a further development of the invention, the artificial neural network is trained to determine a vehicle control command based on the characteristic, position and/or direction of movement of the non-automobile road user, in order to avoid an impending collision with at least one of the non-automobile road users. The output interface is configured to output this vehicle control command to a vehicle control unit. If a bicyclist, for example, moves toward the evaluation device, the artificial neural network determines that a braking procedure should be executed as a vehicle control command. This vehicle control command is output by the output interface to brake actuators of the street vehicle. This results in a braking of the street vehicle. As a result, the vehicle does not collide with the bicyclist. It is particularly advantageous when the bicyclist is moving toward an intersection, if the street vehicle is moving toward the intersection and the bicyclist is moving toward the street vehicle from a region of the intersection that is not visible to the street vehicle. This bicyclist cannot be detected by known surroundings detection sensors in driver assistance systems, e.g. a radar, lidar, or camera. If the bicyclist rings a bell shortly before reaching the intersection, however, the evaluation device can process the sound of the bell. The artificial neural network then determines that a corresponding vehicle control command is to be output, depending on the position and direction of movement of the bicyclist in relation to the evaluation device, in order to prevent a collision. As a result, the safety of the road users prone to danger is improved by the evaluation device.

The operating system according to the invention for a street vehicle for detecting non-automobile road users based on sounds has at least one microphone located on the street vehicle. Audio recordings of non-automobile road users are recorded with this microphone while driving the street vehicle. The operating system also has an evaluation device that can be integrated in the street vehicle. The evaluation device is configured to receive the audio recordings by the microphone as input. The evaluation device is also configured for forward propagation of a trained artificial neural network with these sounds. The artificial neural network is trained to receive at least one characteristic of the non-automobile road user based on the sounds. Moreover, the evaluation device is configured to output the at least one characteristic of the non-automobile road user.

In contrast to the training system according to the invention, the operating system according to the invention has an already trained artificial neural network, and outputs the at least one characteristic. The operating system is a system comprising the individual microphones and the evaluation device, which form a functional unit in the intended use thereof.

The evaluation device is preferably an evaluation device according to the invention.

The subject matter of the invention also comprises use of the operating system according to the invention as a driver assistance system. The driver assistance system can be a purely assisting driver assistance system, or a fully automated driver assistance system.

The operational process according to the invention for detecting non-automobile road users based on sounds has the following steps:
recording the sounds of non-automobile road users,
configuring a trained artificial neural network,
   wherein the trained artificial neural network is forward propagated with theses sounds, and
   receives at least one characteristic of the non-automobile road users as output, and
outputting the at least one characteristic of the non-automobile road user.

In contrast to the training process according to the invention, the operational process according to the invention has an already trained artificial neural network, and outputs the at least one characteristic.

Advantageously, an evaluation device according to the invention or an operating system according to the invention is used for executing the operational process.

In a further development of the invention, a vehicle control command is issued based on the characteristic, position and/or direction of movement of the non-automobile road user in order to prevent an impending collision with the at least one non-automobile road user. This vehicle control command is output to a vehicle control device. As a result, the invention also provides a method for avoiding collisions with road users prone to danger.

The invention also comprises a computer program, configured to uploaded to a memory in a computer. The computer program contains software code with which the steps of the training process and/or operational process according to the invention are carried out when the computer program runs on the computer.

Computer programs normally comprise a sequence of commands by means of which the hardware is activated to execute a specific process, when the program has been uploaded, by which a specific technological result is obtained. When the program in question is used on a computer, the computer program implements a technological effect, specifically the detection of sounds.

A memory is a medium for storing data.

Software is an umbrella term for programs and associated data. The complement to software is hardware. Hardware refers to the mechanical and electronic configuration of a data processing system.

The invention has the advantage, among others, that road users prone to danger can also be detected under poor visibility conditions by a vehicle assistance system, specifically by their sounds. As a result, a collision between a street vehicle and a road user prone to danger can be avoided, even if the road user prone to danger cannot be detected visibly by the driver of the street vehicle, or in the case of an automated driverless street vehicle, by the street vehicle itself.

The invention shall be described comprehensively below based on the following drawings. Therein:

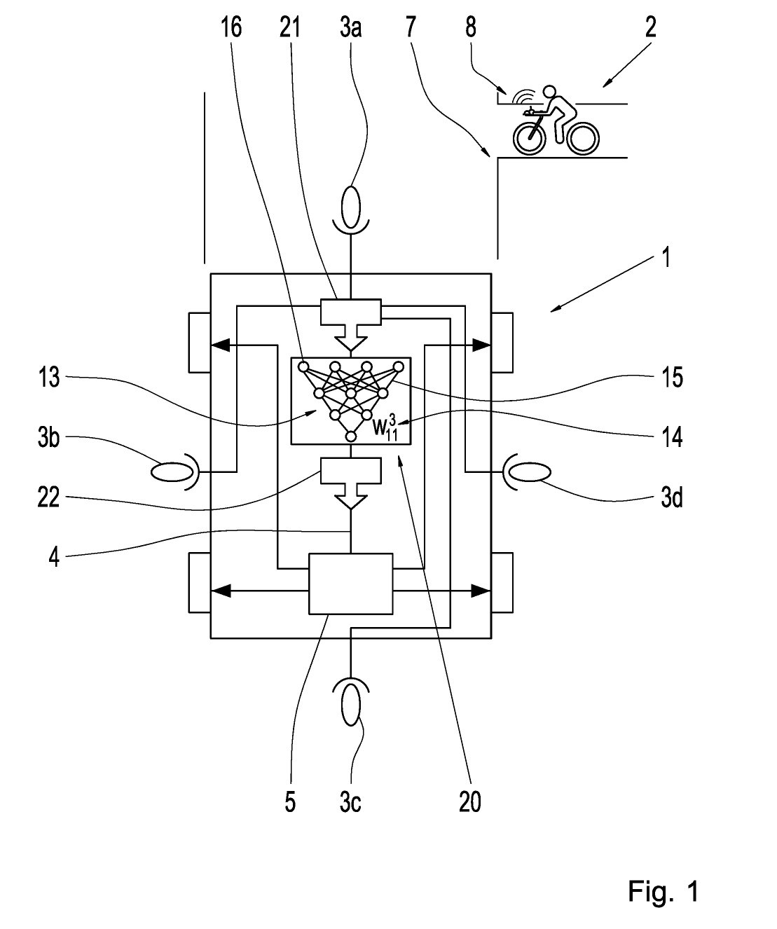

FIG. 1 shows an exemplary embodiment of an evaluation device, integrated in a street vehicle,

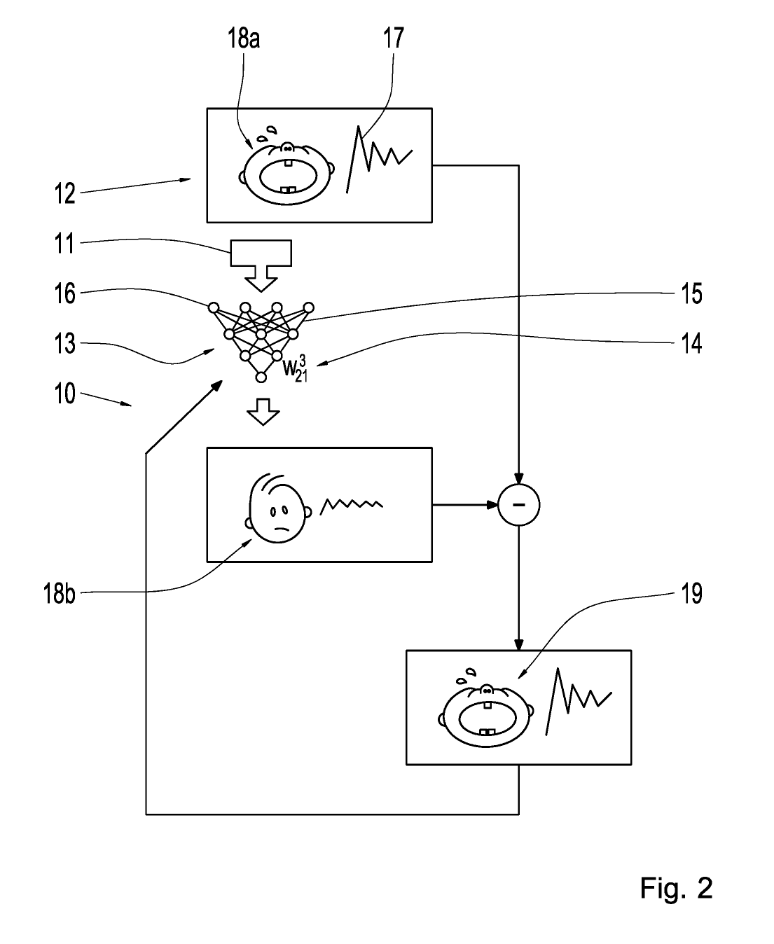

FIG. 2 shows an exemplary embodiment of a training system,

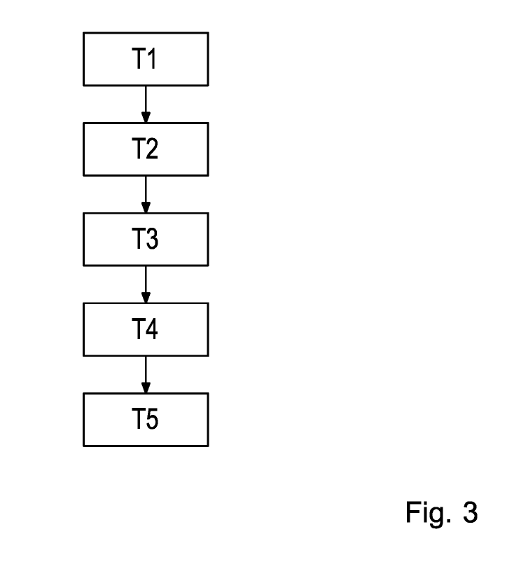

FIG. 3 shows a schematic, exemplary illustration of a training process,

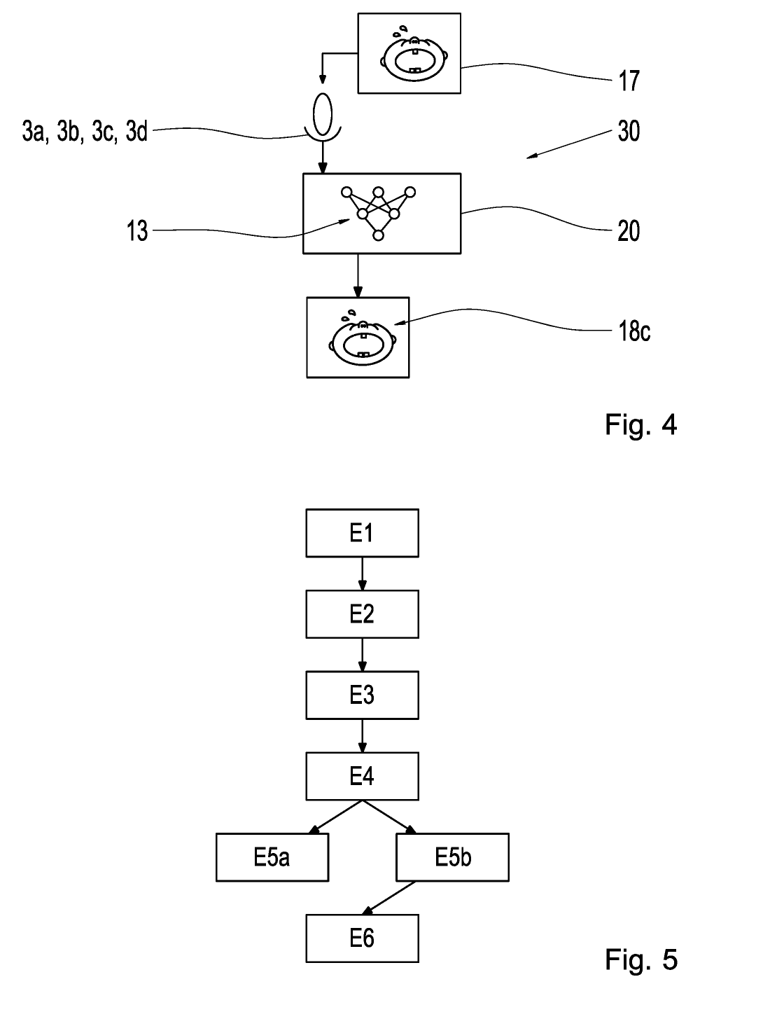

FIG. 4 shows an exemplary embodiment of an operating system, and

FIG. 5 shows a schematic, exemplary illustration of an operational process.

The same reference symbols are used for identical or functionally similar components, if not otherwise specified. The respective relevant components are numbered in the respective figures.

FIG. 1 shows a passenger car as a street vehicle 1. A first directional microphone, microphone 3a, is located in the front region of the street vehicle 1, directed in the direction of travel. A second directional microphone, microphone 3b, is located in a first side region of the street vehicle 1, directed toward the first side. A third directional microphone, microphone 3c, is located in a second side region of the street vehicle 1, directed toward the second side. A fourth microphone, microphone 3d, is located in the rear region of the street vehicle 1, directed away from the first directional microphone. The microphones record sounds from non-automobile road users 2, i.e. prone to danger.

A non-automobile road user 2 in FIG. 1 is a bicyclist, located around a corner at an intersection 7 in relation to the street vehicle, who cannot be detected by visual surroundings detection sensors. The direction of movement of the bicyclist is at a right angle to the direction of movement of the street vehicle. If the movements are maintained, a collision will occur at the intersection between the street vehicle 1 and the non-automobile road user.

Such a collision is prevented in the following manner with an evaluation device 20 according to the invention. The non-automobile road user 2 actuates a bicycle bell 8. The specific sound of the bicycle bell 8 is recorded as an audio recording by the microphone 3a. The audio recording is propagated forward to an artificial neural network 13 via an input interface 21 that the outputs of the microphones 3a, 3b, 3c and 3d are plugged into. The artificial neural network 13 has a fully connected architecture, i.e. each neuron 16 in a layer is connected to each neuron 16 in the subsequent layer via connections 15. The artificial neural network 13 has four layers, specifically the input layer with four neurons 16, a first intermediate layer with three neurons 16, a second intermediate layer with two neurons 16, and an output layer with one neuron 16. Weighting factors 14 for the artificial neural network 13 are set through an error reduction process, i.e. the artificial neural network is trained.

The weighting factor w³₁₁ evaluates the connection 15 between the first neuron 16 of the third layer and the first neuron 16 of the preceding layer, i.e. layer three minus 1.

During a training phase, the artificial neural network learns to determine the position and direction of movement of the non-automobile road user 2 in relation to the evaluation device 20 as a function of the audio recording 17. The artificial neural network 13 outputs a vehicle control command as a function of the determined position and direction of movement. The vehicle control command 4 is output via an output interface 22 on a vehicle control unit 5. The vehicle control unit 5 regulates the longitudinal and lateral control of the street vehicle 1 as a function of the vehicle control command 4, in order to prevent a collision with the road user.

The artificial neural network 13 is trained in the training phase by a training system 10 shown in FIG. 2. The artificial neural network 13 receives target training data 12 via an input interface 11. The target training data comprise audio recordings 17 of a target characteristic 18a. The target characteristic 18a is shown as a symbol, but can also merely be a numerical label by which the artificial neural network 13 knows that this audio recording 17 is an audio recording of a screaming child. The artificial neural network 13 is forward propagated with the target training data 12. The artificial neural network 13 has recorded a sad child in the forward propagation as an actual characteristic 18b that has been determined, who screams more or less than the screaming child. The actual characteristic 18b is depicted as a symbol for simplification. A difference 19 between the actual characteristic 18b and the target characteristic is obtained by subtraction. The difference 19 is fed back to the artificial neural network, in order to set the weighting factors via backward propagation, in order that in the event of a repeated input of a child's scream, the artificial neural network also detects a screaming child as an actual characteristic 18b. This is referred to as learning or training.

The training process is shown in FIG. 3. Audio recordings of the non-automobile road user 2 are recorded by at least one microphone 3a, 3b, 3c and/or 3d while driving the street vehicle 1 in process step T1, and the respective associated target characteristic 18a of the non-automobile road user 2 is provided as target training data 12. The artificial neural network 13 is forward propagated with the target training data 12 in process step T2. The actual characteristic 18b of the non-automobile road user 2 determined with the artificial neural network 13 is recorded in process step T3. The artificial neural network 13 is fed back the difference 19 between the determined actual characteristic 18b and the associated target characteristic 18a in process step T4, in order to set the weighting factors 14 in process step T5.

FIG. 4 shows an operating system 30 that can be used as a driver assistance system. The operating system 30 has at least one microphone 3a, 3b, 3c, and/or 3d, and one evaluation device 20 that has an artificial neural network 13 trained to detect relevant sounds. The audio recording 17 of a screaming child is supplied to the trained artificial neural network 13 via the at least one microphone 3a, 3b, 3c and/or 3d. This corresponds to the process step E1 of the operational process shown in FIG. 5. The evaluation device 20 configures the trained artificial neural network 13. This corresponds to process step E2 in FIG. 5. The trained artificial neural network 13 is forward propagated with the audio recording 17. This corresponds to process step E3 in FIG. 5. The trained artificial neural network 13 records at least one characteristic 18c of the non-automobile road user 2 as an output. This corresponds to process step E4 in FIG. 5. The characteristic 18c, which corresponds to the target characteristic 18a in the trained artificial neural network 13, is subsequently output, e.g. via a human machine interface. This corresponds to process step E5a. As an alternative, or in addition to outputting the characteristic 18c, a vehicle control command 4 is determined on the basis of the characteristic 18c, a position and/or the direction of movement of the non-automobile road user 2, in order to prevent an impending collision with the non-automobile road user 2. This corresponds to process step E5b in FIG. 5. This vehicle control command 4 is output to a vehicle control unit 5 in process step E6 in order for the street vehicle to travel without collisions through corresponding longitudinal and lateral control thereof.

### REFERENCE SYMBOLS

1 street vehicle

2 non-automobile road user

3a microphone

3b microphone

3c microphone

3d microphone

4 vehicle control command

5 vehicle control unit

7 intersection

8 bicycle bell

10 training system

11 input interface

12 target training data

13 artificial neural network

14 weighting factor

15 connection

16 neuron

17 audio recording

18a target characteristic

18b actual characteristic

18c characteristic

19 difference

20 evaluation device

21 input interface

22 output interface

30 driver assistance system

40 operating system

T1-T5 process steps

E1-E6 process steps

1. A training system for a street vehicle for detecting non-automobile road users based on sounds, comprising
an input interface for receiving target training data,
wherein the target training data are audio recordings of the non-automobile road user recorded by at least one microphone located on the street vehicle while driving the street vehicle, and respective associated target characteristics of this non-automobile road user, and wherein
the training system is configured
to forward propagate an artificial neural network with the target training data and to record an actual characteristic of the respective non-automobile road user determined with the artificial neural network in the forward propagation, and
to obtain weighting factors for the connections of neurons in the artificial neural network through backward propagation of the artificial neural network with the difference between the determined actual characteristic and the associated target characteristic.

2. A training process for an artificial neural network for detecting non-automobile road users based on sounds, comprising the following process steps:
provision of audio recordings of the non-automobile road user recorded by at least one microphone located on the street vehicle while driving the street vehicle, and respective associated target characteristics of the non-automobile road user as target training data,
forward propagation of the artificial neural network with the target training data,
recording an actual characteristic of the respective non-automobile road user determined with the artificial neural network,
backward propagation of the artificial neural network with the difference between the recorded actual characteristic and the associated target characteristic, and
determination of weighting factors for connections of neurons in the artificial neural network in a backward propagation.

3. A training process according claim 2, characterized in that the target training data comprise audio recordings of pedestrians, people playing, preferably children, athletes, preferably bicyclists, inline skaters, roller skaters, and/or joggers, people on scooters or in wheel chairs, house pets, preferably dogs, and/or farm animals, preferably horses.

4. An evaluation device for a street vehicle for detecting non-automobile road users based on sounds, comprising
an input interface for receiving the sounds of non-automobile road users,
wherein the evaluation device is configured to forward propagate an artificial neural network with these sounds,
wherein the artificial neural network is trained to record characteristics of the non-automobile road user based on the sounds, and
an output interface for outputting the characteristics of the non-automobile road user.

5. The evaluation device according to claim 4, characterized in that the artificial neural network is an artificial neural network trained in accordance with the training process according to claim 2.

6. The evaluation device according to claim 4, characterized in that the artificial neural network is trained to determine the positions and/or directions of movement of the non-automobile road users in relation to the evaluation device based on the sounds.

7. The evaluation device according to claim 4, characterized in that
the artificial neural network is trained to determine a vehicle control command based on the characteristic, position and/or direction of movement of the non-automobile road user, in order to prevent an impending collision with at least one of the non-automobile road users, and
the output interface is configured to output this vehicle control command to a vehicle control unit.

8. An operating system for a street vehicle for detecting non-automobile road users based on sounds, comprising:
at least one microphone located on the street vehicle for recording audio recordings of the non-automobile road user while driving the street vehicle, and
an evaluation device that can be integrated in the street vehicle, wherein the evaluation device is configured
to record the audio recordings of the microphones as input,
to forward propagate a trained artificial neural network with these sounds, wherein the artificial neural network is trained to determine at least one characteristic of the non-automobile road user based on the sounds, and
to output the at least one characteristic of the non-automobile road user.

9. The operating system according to claim 8, characterized in that the evaluation device is an evaluation device according to claim 4.

10. Use of an operating system according to claim 8 as a driver assistance system.

11. An operational process for detecting non-automobile road users based on sounds, comprising the following steps:
recording the sounds of the non-automobile road users,
configuring a trained artificial neural network,
wherein the trained artificial neural network is forward propagated with these sounds, and
at least one characteristic of the non-automobile road user is recorded as an output, and
outputting at least one characteristic of the non-automobile road user.

12. The operational process according to claim 11, characterized in that an evaluation device according to claim 4, or an operating system according to claim 8 is used for executing the operational process.

13. The operational process according to claim 11, characterized in that
a vehicle control command is determined on the basis of the characteristic, a position, and/or a direction of movement of the non-automobile road user, in order to prevent an impending collision with at least one non-automobile road user, and
this vehicle control command is output to a vehicle control unit.

14. The evaluation device according to claim 5, characterized in that the artificial neural network is trained to determine the positions and/or directions of movement of the non-automobile road users in relation to the evaluation device based on the sounds.

15. The evaluation device according to claim 5, characterized in that
the artificial neural network is trained to determine a vehicle control command based on the characteristic, position and/or direction of movement of the non-automobile road user, in order to prevent an impending collision with at least one of the non-automobile road users, and
the output interface is configured to output this vehicle control command to a vehicle control unit.

16. The evaluation device according to claim 6, characterized in that
the artificial neural network is trained to determine a vehicle control command based on the characteristic, position and/or direction of movement of the non-automobile road user, in order to prevent an impending collision with at least one of the non-automobile road users, and
the output interface is configured to output this vehicle control command to a vehicle control unit.

17. The operational process according to claim 12, characterized in that
a vehicle control command is determined on the basis of the characteristic, a position, and/or a direction of movement of the non-automobile road user, in order to prevent an impending collision with at least one non-automobile road user, and
this vehicle control command is output to a vehicle control unit.
